(19) United States
(12) Patent Application Publication
(10) Pub. No.: US 2006/0125899 A1
(43) Pub. Date: Jun. 15, 2006

(54) Manufacture of tape measures

(76) Inventors: Carl David Cornish, Essex (GB); John Walter Butcher, Essex (GB)

Correspondence Address: PATTON BOGGS LLP, 8484 WESTPARK DRIVE, SUITE 900, MCLEAN, VA, 22102, US

(21) Appl. No.: 10/559,177

(22) PCT Filed: Jun. 2, 2004
(86) PCT No.: PCT/GB04/02355

§ 371 Date: Jan. 10, 2006

(30) Foreign Application Priority Data
Jun. 2, 2003 (GB) 0312591.1

(51) Int. Cl. B41J 2/01

(52) U.S. Cl. 347/104; 347/102

(57) ABSTRACT

A process for printing onto a measuring tape comprising the steps of passing an elongate strip through a printing station having a support over which the strip passes, means to hold the strip taut as it passes over the support and means for monitoring the amount of motion of the strip, monitoring and regulating the tension in the strip passing through the printing station, and delivering print onto the strip by at least one ink jet print head positioned to print onto the strip as it passes over the support wherein control means synchronises operation of the ink jet print head(s) with the monitored motion of the strip, wherein the or at least one of the ink jet print heads uses UV curable ink, and the process further comprises passing said strip past a UV source located downstream of an ink jet print head using UV curable ink.

The present invention relates to the production of measuring tapes.

When printing the graduations on to measuring tapes, every graduation must of course be in its correct position, thereby requiring precise printing over a length of tape which may be many metres.

Many measuring tapes are still printed by the conventional method using a flexible printing plate, which is in the form of a long endless belt, to print all the graduations. The numerals may then be printed in a similar fashion, possibly in a different colour, using a second such belt.

EP 0 434 422 discloses a method of printing measuring tapes using one or more ink jets.

At its most general the present invention provides improvements in the use of ink jet technology to print measuring tapes.

In some aspects of the present invention, the process for printing on to a measuring tape uses an ink jet printer which uses UV curable ink. As its name suggests, this ink can be cured by exposing it to a UV source. This fixes the ink to the substrate after printing, and allows further processing steps to be performed in quick succession.

According to one aspect of the present invention there is provided a process for printing onto a measuring tape comprising the steps of:

passing an elongate strip through a printing station having a support over which the strip passes, means to hold the strip taut as it passes over the support and means for monitoring the amount of motion of the strip;

monitoring and regulating the tension in the strip passing through the printing station; and

delivering print onto the strip by at least one ink jet print head positioned to print onto the strip as it passes over the support wherein control means synchronises operation of the ink jet print head(s) with the monitored motion of the strip,

wherein the or at least one of the ink jet print heads uses UV curable ink, and the process further comprises passing said strip past a UV source located downstream of an ink jet print head using UV curable ink.

The process may involve two printing stations, each having a support over which the strip passes and at least one ink jet print head positioned to print onto the strip as it passes over the support, wherein the printing stations are arranged such that one station prints on a first face of the strip, and another prints on the opposite face of the strip, the strip passing past the UV source in between said two stations.

Alternatively or additionally, there may be a plurality of printing stations each having an ink jet print head using UV curable ink, wherein the strip is passed past a UV source located downstream of each printing station, but upstream of any successive printing station.

Preferably the process also includes driving the strip before it passes through a printing station and after it has passed through all printing stations.

At least one printing station may have print heads capable of printing three or more colours. Preferably these colours are either cyan, magenta and yellow (CMY) or cyan, magenta, yellow and black (CMYK) thereby allowing many different coloured effects to be produced.

The ink jet print heads of the printing stations may use drop-on-demand technology to deliver the ink.

It has also been discovered that it is possible to use ink jet printing to apply a layer of lacquer onto the strip material. Previously the tapes were first printed before being transferred to a lacquering process. Now, by using a UV curable ink and lacquer (which may also be UV curable) applied using ink-jet methods, it is possible for the raw tape to be printed and lacquered in one continuous process.

A second aspect of the present invention provides a process for printing onto a measuring tape comprising the steps of:

passing an elongate strip through a plurality of printing stations, each printing station having a support over which the strip passes, means to hold the strip taut as it passes over the support and means for monitoring the amount of motion of the strip;

monitoring and regulating the tension in the strip passing through the printing stations;

delivering print onto the strip by at least one ink jet print head positioned to print onto the strip as it passes over the support of a printing station, wherein control means synchronises operation of the ink jet print head(s) with the monitored motion of the strip;

subsequently delivering a UV curable lacquer onto the strip at a printing station using at least one ink jet print head positioned to print onto the strip as it passes over the support, thereby coating a first face of the strip with lacquer;

passing the strip past a UV source located downstream of the printing station delivering the lacquer, thereby curing the lacquer.

Preferably the process also includes delivering a UV curable lacquer onto an opposite face of the strip at a subsequent printing station, and curing the lacquer on that opposite face.

Control means may be provided which control the amount of the lacquer delivered onto the strip. For example, the control means may vary the thickness of the lacquer. In one particular embodiment, the thickness of the lacquer may change substantially continuously along a predetermined portion of the strip.

The other preferred and optional features associated with the first aspect of the present invention may also occur in processes according to the second aspect of the present invention.

Embodiments of the invention will now be illustrated with reference to the accompanying drawings, in which:

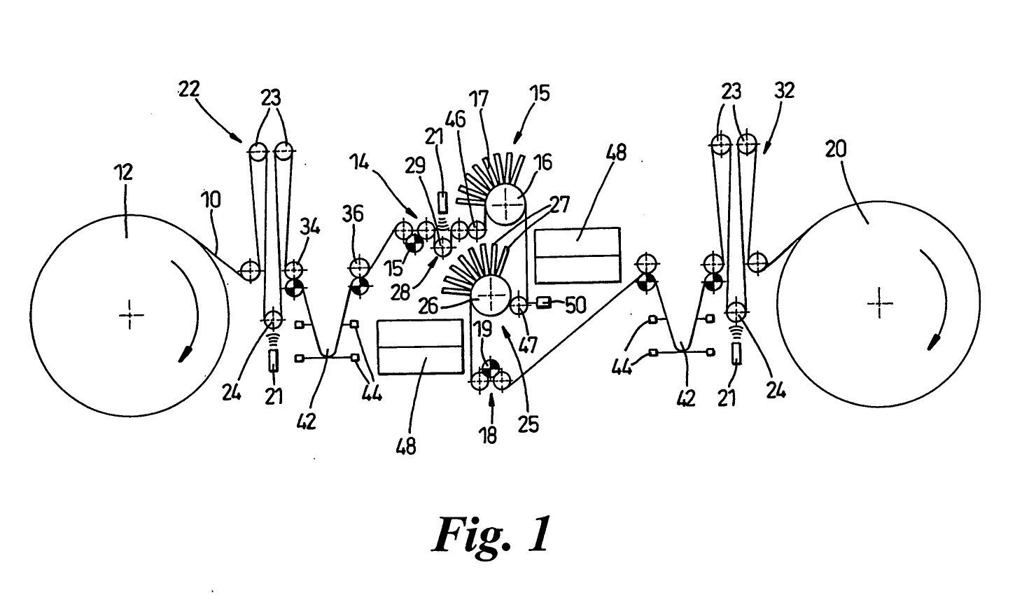

FIG. 1 is a schematic layout of a printing process according to an embodiment of the present invention.

In the embodiment shown in FIG. 1 there are two printing stations 15 and 25. A length of strip material 10 intended to be printed with graduations and/or numbers and subsequently cut into individual tapes is provided on a supply roller 12. The strip material passes through a number of stages including the impression rollers 16 and 26 of the first and second printing stations 15 and 25 respectively before being wound up on take-up roller 20. The supply roller 12 and the take-up roller 20 are preferably driven. In FIG. 1 the quarter shaded rollers represent servo-driven rollers. All other rollers, with the exception of supply roller 12 and take-up roller 20, are free-rotating, although it is of course possible for some or all of these rollers to be driven.

The supply roller 12 is driven in a clockwise direction in FIG. 1 to supply strip material 10 to the printing process. The strip material from the supply roller 12 passes into an accumulator 22 which comprises a set of three rollers. A second accumulator 32 is provided before the take-up roller 20.

The accumulators 22 and 32 each have a pair of rollers 23 on fixed axes and a so-called dancing roller 24 in the bight of strip between the fixed axis rollers 23. The dancing roller 24 moves up and down (in the plane of FIG. 1) as the quantity of strip in the bight between the fixed axis rollers 23 changes. The dancing rollers 24 are biased, either by a spring or similar biasing means, or by gravity, to take up any slack in the bight of material in the accumulators 22 and 32.

The position of the dancing rollers 24 in each bight is monitored by a sensor 21. In the embodiment shown, sensor 21 is an ultrasonic sensor chosen for its reliability and ease of construction. However, other sensors such as dancing arm potentiometers may also be used to monitor the position of the dancing roller. The sensor 21 is connected to a speed control (not shown) which regulates the speed of a motor driving the adjacent roller 12 or 20. This keeps the position of each dancing roller 24 approximately constant, and therefore the amount of strip material in the bight of each accumulator also approximately constant.

This use of accumulators 22 and 32, which are well known per se, largely isolates the drive stations 14 and 18 from the more massive supply and take-up rollers 12 and 20. This helps the drive stations 14 and 18 transport the strip material at a steady speed through the printing stations 15 and 25.

Vibration and snagging of the strip material in the supply and take-up accumulators 22 and 32 can feed through the machine and cause errors in printing accuracy. The supply and take-up accumulators are therefore further isolated in the embodiment of FIG. 1 by providing a tension free loop 42 between each accumulator and the printing stations 15 and 25. The strip material is drawn from the supply coil accumulator 22 through a set of pinch rollers 34, at least one of which is servo-driven. The material is then guided between two vertical plates (not shown-in a parallel plane to FIG. 1) which prevent it wandering laterally. A second pair of pinch rollers 36, at least one of which is also servo-driven, draws the material from the tension free loop 42. One or more sensors monitors the tension free loop (for example by monitoring the position of the lower end of the loop). In the embodiment shown in FIG. 1, these sensors are a series of through beam photo-sensors 44. The sensors 44 feed back to control means which controls the speed of the servo drives to the pinch rollers 34 and 36, thereby maintaining a predetermined desired loop length.

The strip material is driven through the printing stations 15 and 25 by drive stations 14 and 18 each containing a servo-driven roller 15 and 19 respectively. The speed of the material through the printing stations 15 and 25 can be controlled by control means (not shown) connected to the servo-driven roller of each drive station. The drive stations 14 and 18 shown in FIG. 1 have a three roller arrangement. However other arrangements of rollers are also possible, for example pinch rollers like those used to control the tension free loops 42.

In order to ensure accurate printing, it is preferable that the material is held at a constant tension as it passes through printing stations 15 and 25. In the embodiment shown in FIG. 1, this is achieved using a further “short-travel” dancing arm or accumulator 28. Like accumulators 22 and 32, this has a dancing roller 29 and a pair of fixed axis rollers. In the embodiment of FIG. 1, the first of these fixed axis rollers forms part of drive station 14. By monitoring the position of the dancing roller 29 (for example with an ultrasound sensor 21 or a dancing arm potentiometer), and maintaining that position constant, the tension in the strip material as it passes through the printing stations 15 and 25 can be maintained constant. Control means (not shown) controls the speed of the servo-driven rollers 15 and 19 of driving stations 14 and 18 to ensure that the tension between them is maintained constant.

Each printing station 15 and 25 includes an impression roller 16 and 26 over which the material passes whilst being printed and a plurality of print heads 17 and 27, which are ink-jet heads, positioned around the impression rollers 16 and 26, so as to be able to print directly onto the strip material as it passes over the impression roller 16 or 26. In the embodiment of FIG. 1, eight print heads are provided at each printing station 15 and 25. This allows for multi-colour printing (Cyan, Magenta, Yellow and Black (CMYK)) with two print heads per colour at each printing station. The four-colour arrangement allows a large number of composite colours and print effects to be achieved. Providing two print heads per colour allows a resolution of 200 dpi across the width of the material to be achieved. For greater resolutions, more print heads can be provided at each printing station for each colour, with corresponding increases in dpi.

The resolution along the length of the material depends on a number of factors, including the speed of the material through the printing stations. This can be software controlled and the requirements balanced. In the present embodiment a material velocity of 1 m/s is used, with resolutions of between 500 and 700 dpi achievable along the length of the material.

Example print heads are those supplied by Spectra Inc. of Lebanon NH, USA such as sold under the Galaxy PH 256/30 LQ name. This print head has 256 piezo drop-on-demand jets arranged in a single line with 0.25 mm (0.01″) between jets giving a native resolution of 100 dpi (dots per inch). The drive electronics for the heads is also commercially available from Spectra Inc. or from Inca Digital of Cambridge, UK. For example the DPK4-NF driver made by Inca Digital can print at up to 120 m/min at a resolution of 400 dpi using four Spectra print heads.

In the embodiment of FIG. 1, the print heads use ink which is UV curable. Example inks include the Uvijet EV and EG ranges available from Sericol Ltd. of Kent in the UK or the Crystal UGE range available from Coates Electrographics Ltd. of Bath in the UK. These UV curable inks contain very little solvent with molecular changes in the ink, triggered by exposure to UV radiation, causing curing.

In the embodiment of FIG. 1, the print heads utilise “drop-on-demand” ink-jet technology. This results in less wastage of ink compared to continuous flow ink-jet technology. The drop-on-demand ink print heads require less maintenance and the unit cost per print head is lower than for comparable continuous heads. The print heads are also easily interchangeable, allowing use of special ink types and colours.

After passing through each printing station, the face of the strip material which has just been printed on at that station is exposed to UV radiation from a UV source 48. This UV source is typically located in an enclosed chamber and typically comprises one or more high power UV lamps. Exposure to the UV source 48 cures the ink which was applied at the printing station 15 or 25. In the case of the ink applied by the first printing station 15, this allows the strip material to be subsequently passed through second printing station 25 which is arranged to print onto the opposite face of the strip material. If the ink was not cured before passing to the second printing station 25, then there would be a risk that the ink printed by the first printing station 15 would smudge or distort due to contact with impression roller 26. Curing all the ink printed onto the strip material before the material leaves the printing area means that the risk of smudging or distortion due to contact with successive rollers (e.g. drive station 18 or accumulator 32) is reduced or even eliminated.

The cure dose required to be delivered by the UV source 48 depends on the thickness of the ink applied and the intensity of the UV source 48 used. Variations in the wavelength of radiation from the source may also affect curing. As an example, a 8-15 micron thick layer of Crystal UGE ink available from Coates Electrographics Ltd. requires a typical dose of 700 mJ/cm² when a medium pressure mercury lamp (“H” bulb/spectrum) is used.

Located directly before each printing station 15 and 25 is an encoder roller 46 or 47. This roller is not driven but is caused to rotate by the passage of the strip material under tension. The encoder rollers 46 and 47 are arranged so as to run against the face of the strip material which will receive the print from the adjacent printing station 15 or 25. Each such encoder roller 46 and 47 is connected to a shaft encoder or similar device for measuring the number of rotations, partial rotations or fractions of a rotation of the roller and provides an output signal which is related to the speed of the strip material at any particular instant. The output from the encoder roller is used to control and adjust the action of the print heads 17 and 27 to ensure that markings are accurately printed onto the strip material at each printing station.

To ensure alignment accuracy between the printing on each face of the strip material, a predetermined number of encoder pulses from the second encoder roller are recorded to allow for the spatial displacement of the two printing stations 15 and 25. In further development, a registration mark is printed on the first face of the strip material by the first printing station 15. This registration mark is detected by a sensor such as photocell 50 as it passes. The photocell signal can be used to determine if the first printed face of the material has reached the second printing station 25 within a predetermined range of encoder pulses from encoder roller 47. This creates a “registration window” which can be set to a default value on machine start-up, but may also be altered whilst the printing process is running by an operator. This ability to alter the registration window allows adjustment of the tolerance between the two faces to be printed.

In addition, a sensor, such as photocell 50 or a further photocell (not shown), may be used in conjunction with the encoder rollers to check that printed graduations or other marks are correctly positioned on the material after one or more of the printing stations. Such a photocell detects the changes in the intensity of reflected light from the strip material and is thereby able to detect transitions from the background of the material to each of the graduations or marks printed on it. In this way the leading and trailing edges of each graduation or mark can be detected by the sensor. The sensor “views” a fixed point on the path of the moving strip and provides information about when the leading or trailing edges pass this point. Control means, which may be the same as the control means associated with the encoder rollers, receives signals from this sensor and can therefore check that these signals are received at the correct intervals predicted by the speed of the strip (which may be determined from the encoder roller signals). If the control means detects a discrepancy, it can give an alarm and stop printing if the discrepancy exceeds a predetermined tolerance. Alternatively or additionally the control means can correct any discrepancies that do not exceed a predetermined tolerance by varying the relation between the encoder rollers and the print heads, thereby giving automatic regulation of the accuracy of the printing.

Alternatively the photocells in the preceding paragraph could be replaced by a CCD digital cameras connected to a computer with a signal-processing capability. The underlying principle is the same, but the cameras are less susceptible to variations in the definition of a graduation or in the background colour.

Preferably all the servo motors driving the rollers of the process are controlled from a single multi-axis motor controller which is linked to the various control means that allow operator input and feedback control from the various sensors in the process. The same control means may also control the print heads. Alternatively, separate control means may be provided for each of the components of the process, and these multiple control means may be interlinked.

In a development of the above embodiment there may be added further printing stations and additional encoding rollers; accumulators; and/or driving stations. The printing stations may be arranged so as to all print onto the same face of the strip material, or onto alternating faces. The print heads may vary between each printing station, for example with some printing stations only having black print heads and/or printing in grayscale, or with different printing stations being capable of different resolutions.

In another embodiment, a printing station is adapted to apply lacquer to the strip material through the print heads. The lacquer may be subsequently cured by a UV source prior to passing through further printing stations or onto the take-up roller. These further printing stations may include a printing station which applies lacquer to the opposite face of the strip material. In this way there is no need for the strip material forming a tape measure to go through a separate lacquering process after passing through the printing process and therefore the strip material on the take-up roller can be the finished tape product.

Additional printing stations may be supplied before the lacquering station. These may be the normal printing stations which apply markings/graduations and/or numbers to the tape. The ink applied by these printing stations is preferably UV curable and is preferably cured by exposure to a UV source prior to passing through the lacquering station.

The thickness and positioning of the lacquer can be very precisely controlled by the printing process. For example, it would be possible to apply a thicker lacquer to the start of a tape, which is where most of the wear occurs. A thinner coating could therefore be applied to areas less prone to wear, resulting in a more durable tape with the same amount, or even with less lacquer than existing tapes.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A process for printing onto a measuring tape comprising the steps of:
passing an elongate strip through a printing station having a support over which the strip passes, means to hold the strip taut as it passes over the support and means for monitoring the amount of motion of the strip;
monitoring and regulating the tension in the strip passing through the printing station; and
delivering print onto the strip by at least one ink jet print head positioned to print onto the strip as it passes over the support wherein control means synchronises operation of the ink jet print head(s) with the monitored motion of the strip,
wherein the or at least one of the ink jet print heads uses UV curable ink, and the process further comprises passing said strip past a UV source located downstream of an ink jet print head using UV curable ink.

2. A process according to claim 1 wherein there are at least two printing stations, each having: a support over which the strip passes and at least one ink jet print head positioned to print onto the strip as it passes over the support, and further wherein
the printing stations are arranged such that one station prints on a first face of the strip, and another prints on the opposite face of the strip, the strip passing past said UV source in between said two stations.

3. A process according to claim 1 or claim 2 wherein there are a plurality of printing stations each having an ink jet print head using UV curable ink, and the strip is passed past a UV source located downstream of each printing station, but upstream of any successive printing station.

4. A process according to any one of the preceding claims further including driving the strip before it passes through a printing station and after it has passed through all printing stations.

5. A process according to any one of the preceding claims wherein at least one printing station has print heads capable of printing three or more colours.

6. A process according to any one of the preceding claims wherein the or at least one of the ink jet print heads uses drop-on-demand.

7. A process according to any one of the preceding claims wherein the strip is kept at constant tension as it passes through the or each printing station.

8. A process for printing onto a measuring tape comprising the steps of:
passing an elongate strip through a plurality of printing stations, each printing station having a support over which the strip passes, means to hold the strip taut as it passes over the support and means for monitoring the amount of motion of the strip;
monitoring and regulating the tension in the strip passing through the printing stations;
delivering print onto the strip by at least one ink jet print head positioned to print onto the strip as it passes over the support of a printing station, wherein control means synchronises operation of the ink jet print head(s) with the monitored motion of the strip;
subsequently delivering a UV curable lacquer onto the strip at a printing station using at least one ink jet print head positioned to print onto the strip as it passes over the support, thereby coating a first face of the strip with lacquer; and
passing the strip past a UV source located downstream of the printing station delivering the lacquer, thereby curing the lacquer.

9. A process according to claim 8, further comprising the step of passing the strip past a UV source located downstream of the printing station delivering the print, thereby curing the print.

10. A process according to claim 8 or claim 9, further comprising the step of:
delivering a UV curable lacquer onto the opposite face of the strip at a further printing station and passing the strip past a UV source located downstream of said further printing station, thereby curing said lacquer on the opposite face.

11. A process according to any one of claims 8 to 10 wherein control means controls the amount of lacquer delivered onto a face of the strip at any particular time, thereby allowing the thickness of lacquer to be varied along the tape.

12. A process according to claim 11 wherein the control means causes the amount of lacquer delivered onto a face of the strip to vary continuously along a predetermined length of the strip.

13. A process according to any one of claims 8 to 12 wherein there are a plurality of printing stations, and at least two of the printing stations are arranged such that one station prints ink onto a first face of the strip, and another prints on the opposite face of the strip, the strip passing past a UV source in between said two stations.

14. A process according to any one of claims 8 to 13 wherein there are a plurality of printing stations having an ink jet print head using UV curable ink, and the strip is passed past a UV source located downstream of each printing station, but upstream of any successive printing station.

15. A process according to any one of claims 8 to 14 further including driving the strip before it passes through a printing station and after it has passed through all printing stations.

16. A process according to any one of claims 8 to 15 wherein at least one printing station has print heads capable of printing three or more colours.

17. A process according to any one of claims 8 to 16 wherein the or at least one of the ink jet print heads uses drop-on-demand.

18. A process according to any one of claims 8 to 17 wherein the strip is kept at constant tension as it passes through the or each printing station.

19. A process substantially as herein described with reference to, or as illustrated in, the accompanying drawing.
